(19) United States
(12) Patent Application Publication
(10) Pub. No.: US 2021/0016533 A1
(43) Pub. Date: Jan. 21, 2021

(54) MOULDING STATION FOR SHEAR WEB PRODUCTION AND A MANUFACTURING METHOD THEREOF

(71) Applicant: LM WIND POWER US TECHNOLOGY APS, Kolding (DK)

(72) Inventors: Shihou WEI, New Harbour City Jiangyin, Jiangsu (CN); Liu LIANG, New Harbour City Jiangyin, Jiangsu (CN); Hua HUANG, New Harbour City Jiangyin, Jiangsu (CN); John ZHENG, New Harbour City Jiangyin, Jiangsu (CN)

(21) Appl. No.: 16/981,541

(22) PCT Filed: Mar. 19, 2018
(86) PCT No.: PCT/CN2018/079434

§ 371 Date: Sep. 16, 2020

(51) Int. Cl. B29D 99/00; B29C 37/00

(52) U.S. Cl. CPC B29D 99/0025; B29C 37/0007

(57) ABSTRACT

This invention relates to a moulding station and a method using such moulding station, wherein the moulding station comprises a first web mould and a second web mould arranged on different levels. The first web mould is configured for manufacturing a first shear web and the second web mould is configured for manufacturing a second shear web. The first and second shear webs are moved to a post-moulding sub-station for assembly or finishing steps or to a transfer area. The present invention enables the sets of shear webs to be manufactured at multiple levels, thereby increasing the production capacity.

### TECHNICAL FIELD

The present invention relates to a moulding station comprising a plurality of web moulds each comprising a moulding surface for moulding a shear web component, wherein each web mould has a first end, an opposite second end, a first side and an opposite second side.

The present invention further relates to a method of manufacturing shear webs using the above moulding station.

### BACKGROUND

It is known to manufacture shear webs in a web mould while the blade shell is manufactured separately in a blade mould. Normally, two or more shear webs are positioned within the wind turbine blade to add support to the blade shell. The shear webs are lifted into position and attached to one blade shell part, after which another blade shell part is moved into position and attached to the shear webs and the one blade shell part.

US 2017/0151711 A1 discloses such a manufacturing method of a wind turbine blade where the shear webs are guided into the correct position when moving the two blade shell part into contact with each other. The two blade moulds are shaped to each form a part of the wind turbine blade, wherein the two blade shell parts form the aerodynamics profile of the wind turbine blade.

US 2017/0320275 A1 discloses such a web mould for manufacturing an I-shaped shear web which is later lifted out of the web mould and into position on the blade part. The web moulds are normally shaped to form a particular shear web profile designed for that wind turbine blade.

Using separate web moulds and blade moulds take up more space and reduce the available spacing for other production lines, therefore reducing the overall production capacity of the manufacturing facility. Thus, a need for optimising the production capacity exists.

### OBJECT OF THE INVENTION

An object of the invention is to provide a web mould system and a method that solve the abovementioned problem.

Another object of the invention is to provide a web mould system and method that increases the manufacturing capacity.

A further object of the invention is to provide a web mould system and a method that allows for production of multiple shear webs at the same time.

### DETAILED DESCRIPTION OF THE INVENTION

One object of the invention is achieved by a moulding station comprising a first web mould and at least a second web mould, the first web mould comprising a moulding surface for moulding a first shear web, the second web mould comprising a moulding surface for moulding a second shear web, wherein each of said first and second web moulds comprises a first end, a second end, a first side and a second side, characterised in that the first web mould is arranged at a ground level and the second web mould is arranged at an upper level located above the ground level.

This provides a compact moulding station comprising multiple web moulds arranged at multiple levels, thereby increasing the production capacity without increasing the required production area. This allows large shear webs for large wind turbine blades to be manufactured simultaneously without taking up additional production space. This also allows multiple production lines to be arranged within the same manufacturing facility.

Conventional production lines have all blade and web moulds arranged at ground level. Hence, only a limited number of production lines can be arranged within the manufacturing facility at the same time. This reduces the overall production capacity. Alternatively, the blade and web moulds of a current production line may be removed and replaced by new blade and web moulds when starting production of a different wind turbine blade. However, this is a time-consuming process and increases the production downtime.

According to one embodiment, said upper level is formed by a working platform extending in a longitudinal direction and in a transverse direction, wherein said first web mould is arranged below said working platform.

The manufacturing facility may be constructed as a permanent structure or a temporary structure defining an overall production area. The ground level is formed by a floor, e.g. a concrete floor or a temporary made floor, of the production area which defines a ground level floor space. The upper level is defined as an intermediate floor located between the ground level and a ceiling of the production area which defines an upper level floor space. For example, a first upper level may be located above the ground level and a further second upper level may be located above the first upper level, and so forth. This increases the total floor space for the production lines.

The upper level may be formed by a working platform extending in a longitudinal direction and further in a transverse direction. The working platform extends over a portion of the ground level and defines a dedicated floor area. The working platform may be formed as a permanent built-in structure, or a semi-permanent structure which can be dismantled and re-positioned. Alternatively, the working platform may be formed as a moveable structure which can be moved along the ground level. For example, two or more working platforms may be arranged at the same upper level and may be spaced apart or abutting each other. For example, at least a first working platform may be arranged at the first upper level and at least a second working platform may be arranged at the second upper level. The working platform may thus function as a mezzanine for the production of shear webs.

Each working platform is adapted for the installation of one or more web moulds suitable for manufacture of shear webs. The working platform may further be prepared for the installation of a lifting system, as described later, for at least lifting the shear web out of the web moulds. Additionally, one or more further web moulds may be installed below the working platform. The bottom of the working platform and/or the spacing below the working platform may be prepared for the installation of a further lifting system for at least lifting the shear web out of the further web moulds. This provides a compact production line allowing the shear webs to be manufactured at multiple levels.

Alternatively, one or more blade moulds and an associated lifting system may be installed before or on the working platform. This allows the blade shell parts and shear webs to be manufactured in a combined production line.

Alternatively, one or more blade moulds and an associated lifting system may be installed before and further on the working platform. This allows the blade shell parts to be manufactured at multiple levels.

According to one embodiment, at least a third web mould is further arranged at the ground level relative to the first web mould and/or at the upper level relative to the second web mould, the third web mould comprising a moulding surface for moulding at least a third shear web.

The length and width of the working platform may be adapted to enable the installation of a number of individual web moulds. Similarly, a number of individual web moulds may be installed at the ground level. For example, two, three, four or more web moulds may be arranged at the ground level and/or at the upper level. For example, one or more first web moulds may be installed on the first upper level while one or more second web moulds may be installed on the second upper level. This allows for the production of multiple shear webs on more than one level.

For example, a first set of web moulds for a first wind turbine blade may be arranged at ground level. The individual web moulds of the first set may all be arranged adjacent to the working platform or below the working platform. Alternatively, some web moulds may be arranged adjacent to the working platform while others are arranged below the working platform. A second set of web moulds for a second wind turbine blade may be arranged at the working platform. Alternatively, the individual web moulds of the first set and/or the second set may be partly arranged on both the ground level and the upper level. Further sets of web moulds may be arranged in a similar manner.

According to one embodiment, said first or second web mould and said third web mould are aligned in the longitudinal direction.

The dimensions of the individual web moulds are adapted to the size and shape of the shear web or shear web segments. For example, the shear webs may be formed as single continuous piece. This requires a web mould extending at least the total length of that shear web. For example, the shear webs may be formed by a number of shear web segments that are joined together. This requires one or more web moulds extending at least the local length of that shear web segment.

The web moulds, e.g. the first or second web mould and the third web mould, on a selected level may be arranged continuously along the longitudinal direction. This forms a continuous production line. Further, the web moulds on another selected level may also be arranged continuously along the longitudinal direction.

This arrangement is e.g. suited for the production of sets of shear webs, e.g. continuous shear webs, for large wind turbine blades, e.g. having a blade length of 50 meters or more.

According to one embodiment, said first or second web mould and said third web mould are aligned in the transverse direction.

Alternatively, the web moulds, e.g. the first or second web mould and the third web mould, on a selected level may be arranged in parallel along the transverse direction. This may form a number of parallel production lines. Further, the web moulds on another selected level may also be arranged in parallel along the transverse direction.

This arrangement is e.g. suited for parallel production of different sets of shear web segments for different wind turbine blades. Further, any web moulds not currently used in production may be stored with the manufacturing facility without limiting the production capacity, thereby reducing the production downtime.

In a further alternative, one or more web moulds of a set may extend in an inclined angle relative to the longitudinal direction. This may e.g. be suited for pre-bend wind turbine blades.

In yet a further alternative, one web mould, e.g. a web mould for a first shear web segment, of a set may extend in a first direction while another web mould, e.g. a web mould for a second shear web segment, of said set may extend in a second direction. This may e.g. be suited for production of segmented shear webs.

According to one embodiment, the moulding station further comprises a lifting system configured to lift a selected shear web between a first position and a second position, wherein said lifting system is configured to move relative to at least the first or second web mould.

As mentioned earlier, the moulding station may further comprise at least one lifting system configured to lift a shear web component out of a selected web mould and move it to another position. The lifting system may be formed as a gantry crane unit, an overhead crane unit or another suitable lifting system. The lifting system is arranged relative to the web mould(s) so that the lifting means can be moved in the longitudinal direction and/or transverse direction relative to the web mould(s). This allows the shear web component to move from a first position defined by the web mould and to the second position.

In example, a local lifting system may be installed at each level for each production line or a common lifting system may be installed at that level suitable for use in all production lines. The (common) lifting system may extend further over a (common) post-moulding sub-station defining by the above second position. The lifting systems for each production line and/or each level may be operated independently. The lifting system on one level may differ from the lifting system on another level. For example, a gantry crane unit may be used on the ground level while an overhead crane unit may be used on the upper level.

Alternatively, the lifting system may comprise dedicated lifting devices and/or transport devices. The lifting devices may be configured to perform the lifting of the shear web while the transport devices may be configured to perform the transport of the shear web between the first and second positions. The transport and lifting devices may be configured as separate devices or integrated devices.

In example, the shear web may be moved into a dedicated transfer area defining the second position. In this transfer area, the shear webs may be prepared for installation and/or rotated into an installation position. The shear webs may be transferred from this second position and to a storage area for later installation or directly to the blade mould or cradle for installation.

According to one embodiment, the moulding station further comprises at least one post-moulding sub-station arranged at the ground level or the upper level.

A post-moulding sub-station may be arranged in extension to each production line, as described earlier. The post-moulding sub-station may be configured to receive and hold at least one shear web component, preferably a set of shear webs. The post-moulding sub-station may simply comprise a cradle for temporary holding the shear web(s) before it/they is/are transferred to the blade shell for installation. The set of shear webs may thus be assembled directly in the blade mould or in a post-moulding cradle.

Alternatively, the post-moulding sub-station may be formed as an assembly station for assembling the set of shear webs prior to installation in the blade shell. The post-moulding sub-station may comprise a support frame or structure for holding the shear webs during assembly. The individual shear web segments may further be joined together to form the respective shear web in the assembly station. Temporary spacer means, e.g. interconnecting or telescopic rods, may be fitted between the shear webs to maintain the distance between the shear webs during installation.

The support frame with shear webs may then transferred to the blade shell and installed. Once the installation process is completed, the spacer means and the support frame may be removed and reused for another set of shear webs. This allows the set of shear webs to be assembled in the moulding station prior to installation.

Another lifting system, e.g. an overhead crane unit, may be used to transfer the set of shear webs between the post-moulding sub-station and the blade mould or cradle.

Alternatively, a common post-moulding sub-station may be provided at one or more levels for all production lines located on that level. Optionally, a single common post-moulding sub-station may be provided for all levels and all production lines. This singe common post-moulding sub-station may be adapted to receive and hold the various set of shear webs. This reduces the total number of sub-stations.

The post-moulding sub-station(s) on the ground levels and on the upper level may be aligned in the vertical direction to form a stacked configuration. Alternatively, the post-moulding sub-stations on the ground and upper levels may be offset relative to each other in the vertical direction.

One or finishing steps may optionally be performed on the shear webs in the post-moulding sub-station.

One object of the invention is also achieved by a method of manufacturing a shear web for a wind turbine blade, the method comprises the steps of:
providing a moulding station comprising a first web mould and at least a second web mould,
manufacturing a first shear web in said first web mould using a moulding process,
further manufacturing a second shear web in said second web mould using a moulding process, characterised in that
   said manufacturing of the first shear web is performed at a ground level while said further manufacturing of the second shear web is performed at an upper level, the upper level being located above the ground level.

This provides a method of manufacturing multiple set of shear webs at multiple levels, thereby reducing the cycle time for producing multiple wind turbine blades at the same manufacturing facility. This increases the production capacity of the moulding station without increasing the required production area.

The individual shear webs for a particular wind turbine blade can thus be produced simultaneously in different web moulds. This reduces the total cycle time. The shear webs are afterwards transferred directly to the blade mould or cradle for installation or to a post-moulding sub-station for assembly prior to installation.

Large shear webs or shear web segments can advantageously be manufactured using the present invention without having to increase the production area. The shear webs for one type of wind turbine blade are thus manufactured in one production line, e.g. on the upper level, while the shear webs for another type of wind turbine blade are manufactured in another production line, e.g. on the ground level. Thereby increasing the number of shear webs which can be manufacture at the same time.

The present invention further reduces the need for moving the web moulds in and out of the production area, thereby reducing the production downtime.

According to one embodiment, the method further comprises the step of:
moving said first or second shear web to a post-moulding sub-station using a lifting system of the moulding station.

The individual shear webs may be moved out of the web moulds and into the post-moulding sub-station using one or more lifting systems. One or more finishing steps may be performed on the shear webs in the post-moulding sub-station. Additionally or alternatively, the set of shear webs may be assembled within the post-moulding substation. Once assembled, the set of shear webs may be transferred to the blade mould or cradle for installation.

According to one embodiment, a first set of shear webs of one wind turbine blade are manufactured at one level while a second set of shear webs of another wind turbine blade are manufactured at another level.

A first set of shear webs may be manufactured on the ground level while a second set of shear webs may be manufactured at the upper level, or vice versa. Alternatively, both the first and second sets of shear webs may be manufactured on the same level. The web moulds for a respective set of shear webs may be grouped together to facilitate the manufacturing process and reduce the production cycle time. This is suitable for the manufacture of large continuous shear webs.

According to one embodiment, a first set of shear webs of one wind turbine blade are manufactured in selected web moulds at the ground and upper levels and while a second set of shear webs of another wind turbine blade are manufactured in further selected web moulds at the ground and upper levels.

Alternatively, the first set of shear webs may be manufactured on both the ground and upper levels using dedicated web moulds on each level. Similarly, the second set of shear webs may be also manufactured on both the ground and upper levels using dedicated web moulds on each level. The dedicated web moulds on a selected level may be adapted to manufacture a portion of the combined shear web or a specific shear web of said set. The dedicated web moulds on another selected level may be adapted to manufacture another portion of the combined shear web or another specific shear web of said set.

In example, the manufacture of large shear web segments or first shear web segments may be performed on one level while the manufacture of minor shear web segments or second shear web segments may be performed on another level. In example, the manufacture of the I-shaped or C-shaped shear webs may be performed on one level while the manufacture of reinforcing shear webs may be performed on another level. The reinforcing shear webs may include a trailing edge shear web, a leading edge shear web or another reinforcing shear web.

### DESCRIPTION OF DRAWINGS

The invention is explained in detail below with reference to embodiments shown in the drawings, in which

FIG. 1 shows a wind turbine,

FIG. 2 shows an exemplary embodiment of the wind turbine blade having a base aerodynamic profile,

FIG. 3 shows a first exemplary embodiment of a moulding station according to the invention,

FIG. 4 shows a second exemplary arrangement of the set of web moulds,

FIG. 5 shows a third exemplary arrangement of the set of web moulds,

FIG. 6 shows a second exemplary embodiment of the moulding station,

FIG. 7 shows a third exemplary embodiment of the moulding station, and

FIG. 8 shows a fourth exemplary embodiment of the moulding station.

### LIST OF REFERENCES

1. Wind turbine
2. Wind turbine tower
3. Nacelle
4. Hub
5. Wind turbine blades
6. Pitch bearing
7. Blade root
8. Tip end
9. Leading edge
10. Trailing edge
11. Blade shell
12. Pressure side
13. Suction side
14. Blade root portion
15. Aerodynamic blade portion
16. Transition portion
17. Blade length of wind turbine blade
18. Chord length of wind turbine blade
19. Moulding station
20. Ground level
21. Upper level
22. Working platform
23. First web mould
24. Second web mould
25. Third web mould
26. Shear web component
27. Second position
28. Blade mould
29. Blade cradle
30. First end of web mould
31. Second end of web mould
32. First side of web mould
33. Second side of web mould
34. Moulding surface
35. First lifting system
36. Post-moulding sub-station
37. Second lifting system

The listed reference numbers are shown in abovementioned drawings where no all reference numbers are shown on the same figure for illustrative purposes. The same part or position seen in the drawings will be numbered with the same reference number in the figures.

### DETAILED DESCRIPTION OF THE DRAWINGS

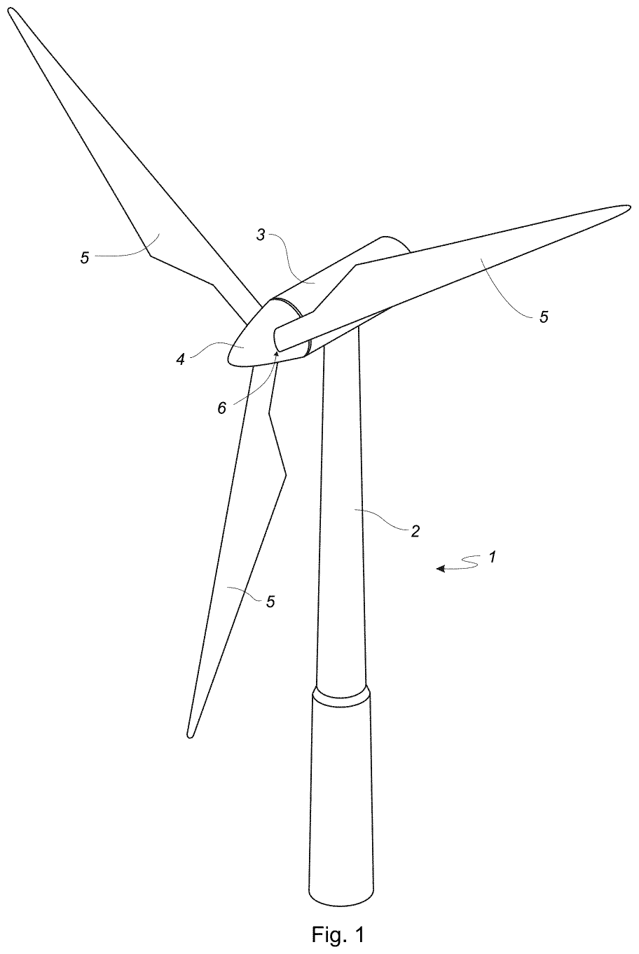

FIG. 1 shows a modern wind turbine 1 comprising a wind turbine tower 2, a nacelle 3 arranged on top of the wind turbine tower 2, and a rotor defining a rotor plane. The nacelle 3 is connected to the wind turbine tower 2, e.g. via a yaw bearing unit. The rotor comprises a hub 4 and a number of wind turbine blades 5. Here three wind turbine blades are shown, but the rotor may comprise more or fewer wind turbine blades 5. The hub 4 is connected to a drive train, e.g. a generator, located in the wind turbine 1 via a rotation shaft.

The hub 4 comprises a mounting interface for each wind turbine blade 5. A pitch bearing unit 6 is optionally connected to this mounting interface and further to a blade root of the wind turbine blade 5.

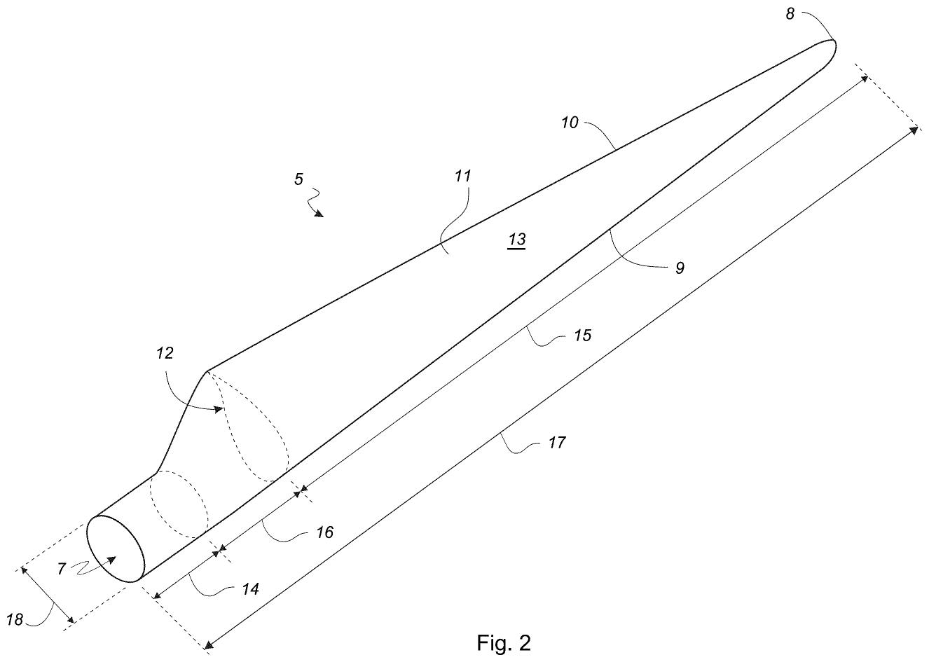

FIG. 2 shows a schematic view of the wind turbine blade 5 which extends in a longitudinal direction from a blade root 7 to a tip end 8. The wind turbine blade 5 further extends in a chordwise direction from a leading edge 9 to a trailing edge 10. The wind turbine blade 5 comprises a blade shell 11 having two opposite facing side surfaces defining a pressure side 12 and a suction side 13 respectively. The blade shell 11 further defines a blade root portion 14, an aerodynamic blade portion 15, and a transition portion 16 between the blade root portion 14 and the aerodynamic blade portion 15.

The blade root portion 14 has a substantially circular or elliptical cross-section (indicated by dashed lines). The blade root portion 14 together with a load carrying structure, e.g. a main laminate combined with a shear web or a box beam, are configured to add structural strength to the wind turbine blade 5 and transfer the dynamic loads to the hub 4. The load carrying structure extends between the pressure side 12 and the suction side 13 and further in the longitudinal direction.

The blade aerodynamic blade portion 15 has an aerodynamically shaped cross-section (indicated by dashed lines) designed to generate lift. The cross-sectional profile of the blade shell 11 gradually transforms from the circular or elliptical profile into the aerodynamic profile in the transition portion 16.

The wind turbine blade 5 has a blade length 17 of at least 35 metres, preferably at least 50 metres, measured in the longitudinal direction. The wind turbine blade 5 further has a chord length 18 as function of the blade length 17 measured in the chordwise direction, wherein the maximum chord length is found between the blade aerodynamic blade portion 15 and the transition portion 16.

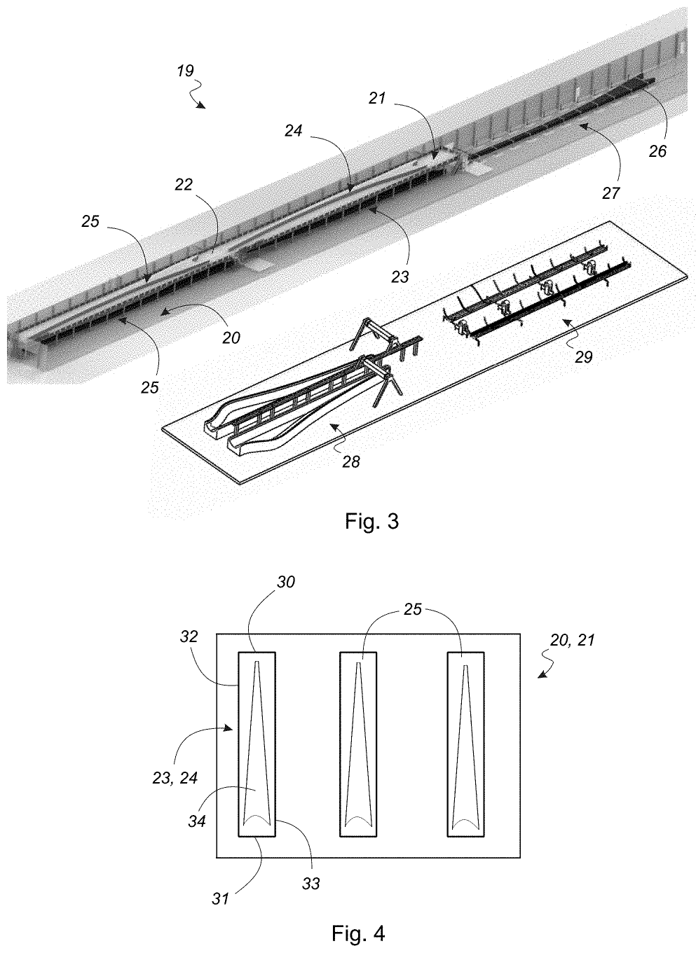

FIG. 3 shows an exemplary embodiment of a moulding station 19 according to the invention, where the moulding station 19 comprises a ground level 20 and an upper level 21.

The ground level 20 is here formed by a floor of a manufacturing facility. The upper level 21 is formed by a working platform 22 extending in a longitudinal direction and further in a transverse direction. The working platform 22 is here formed as a semi-permanent structure positioned defining a defined area between the working platform 22 and the floor.

Here, a first web mould 23 is arranged at the ground level 20 below the working platform 22 while a second web mould 24 is arranged at the upper level 21. At least a third web mould 25 is further arranged at both the ground and upper levels 20, 21 relative to the first and second web moulds 23, 24, respectively. A set of web moulds is thus provided at the ground level 20 and a set of web moulds is further provided at the upper level 21.

The first and third web moulds 23, 25 extend continuously along the longitudinal direction, as illustrated in FIG. 3 to form one continuous production line. Further, the second and third web moulds 24, 25 extend continuously along the longitudinal direction to form another continuous production line.

A second position 27 defined by a transfer area is arranged in extension of the first web mould 23, as illustrated in FIG. 3. The second position 27 is adapted to receive a shear web component 26, e.g. a first, second or third shear web, manufactured in a selected web mould, e.g. the first, second or third web mould.

A first lifting system (shown in FIG. 6) is used to move the shear web components 26 of at least the ground level 20 between a first position defined by the first or third web mould 23, 25 and the second position 27.

A second lifting system (shown in FIG. 6) is used to transfer the shear web components 26 between the second position 27 and a blade mould 28 or a blade cradle 29 for installation. Alternatively or additionally, the second lifting system is also used to directly move the shear web components 26 from the second or third web mould 24, 25 and into the blade mould 28 or blade cradle 29 or into the second position 27.

FIG. 4 shows a second arrangement of the set of web moulds where the first and third web moulds 23, 25 at ground level 20 extend in the transverse direction, thereby forming a row of parallel production lines. Alternatively or additionally, the second and third web moulds 24, 25 at upper level 21 extend in the transverse direction, thereby forming another row of parallel production lines.

Each of the web moulds 23, 24, 25 has a local length extending from a first end 30 to a second end 31 and a local width extending from a first side 32 to a second side 33. Each web mould 23, 24, 25 has a moulding surface 34 for laying up the materials of the shear web component 26 during the moulding process.

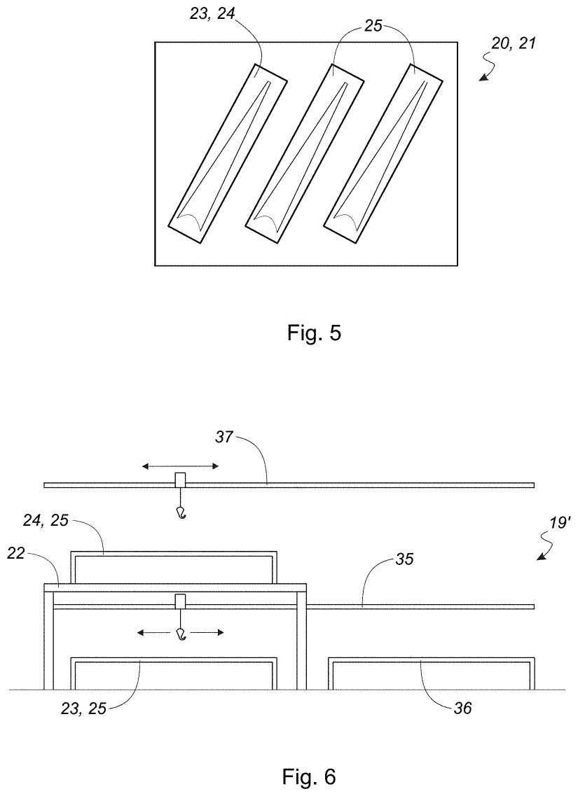

FIG. 5 shows a third arrangement of the set of web moulds. Unlike the second arrangement in FIG. 4, the first and third web moulds 23, 25 at the ground level 20 are here positioned in an angle relative to the longitudinal direction. Alternatively or additionally, the second and third web moulds 24, 25 at the upper level 21 are here positioned in an angle relative to the transverse direction.

FIG. 6 shows a second exemplary embodiment of the moulding station 19′, wherein the first lifting system 35 is arranged relative to the working platform 22. The first lifting system 35 extends over the first or third web mould 23, 25 and further over a post-moulding sub-station 36 at the second position 27. The first lifting system 35 is configured to move the shear web component 26 between a selected web mould on the ground level 20 and the post-moulding sub-station 36.

Further, the second lifting system 37 is arranged relative to the working platform 22. The second lifting system 37 extends over the second or third web mould 24, 25 and over the post-moulding sub-station 36. The second lifting system 37 is configured to move the shear web component 26 between a selected web mould on the upper level 21, the post-moulding sub-station 36 and the blade mould 28 or blade cradle 29.

As illustrated in FIG. 6, only one web mould may be arranged at ground level 20 below the working platform 22. Alternatively or additionally, only one web mould be arranged on the working platform 22 and thus at the upper level 21.

Optionally, one or more finishing steps are performed on the shear web component 26 in the post-moulding sub-station 36 before installation.

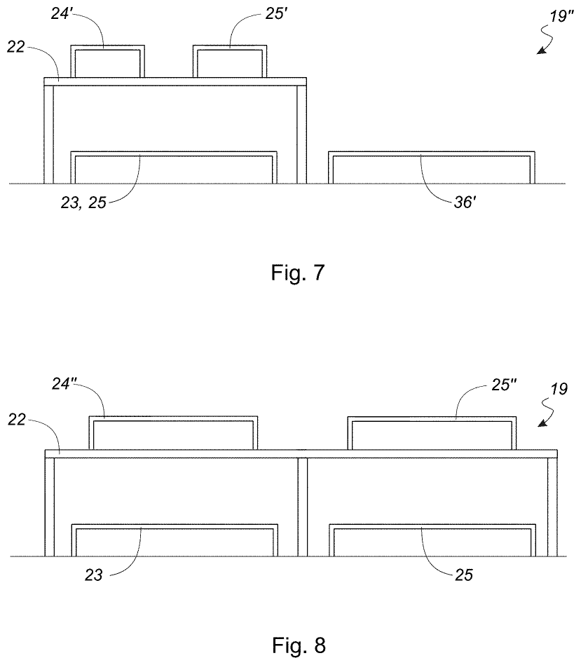

FIG. 7 shows a third exemplary embodiment of the moulding station 19″, wherein the web moulds at the ground and upper levels 20, 21 have different configurations. Here, the first web mould 23 and/or the third web mould 25 at the ground level 20 is/are configured for the manufacture of shear webs or segments thereof having a length of 30 meters, preferably 50 meters, or more.

The second web mould 24 and/or the third web mould 25 at the upper level 21 is/are configured for the manufacture of shear webs or segments thereof having a length of 30 meters, preferably 50 meters, or less.

As illustrated in FIG. 7, the web moulds at the ground level 20 extend in a first direction, e.g. the longitudinal direction, while the web moulds at the upper level 21 extend in a second direction, e.g. the transverse direction.

The post-moulding sub-station 36′ is here configured to receive a set of shear webs for a particular wind turbine blade 5, wherein the individual shear webs are assembled prior to being transferred to the blade mould 28 or blade cradle 29 for installation. The assembly is performed by joining any shear web segments and/or to interconnect the individual shear webs via temporary spacer means. Optionally, the shear webs are rotated into an installation position before, during or after the assembly process.

FIG. 8 shows a fourth exemplary embodiment of the moulding station 19, wherein the web moulds at the ground and upper levels 20, 21 have different configurations.

Here, the first web mould 23 and/or the third web mould 25 at the ground level 20 is/are configured for the manufacture of shear webs or segments dedicated for a first wind turbine blade 5. The second web mould 24″ and/or the third web mould 25″ at the upper level 21 is/are configured for the manufacture of shear webs or segments dedicated for a second wind turbine blade 5.

The first and second wind turbine blades 5 have different blade lengths, different aerodynamic profiles, and/or different structural properties.

The abovementioned embodiments may be combined in any combinations without deviating from the present invention.

1. A moulding station comprising a first web mould (23) and at least a second web mould (24), the first web mould (23) comprising a moulding surface (34) for moulding a first shear web, the second web mould (24) comprising a moulding surface (34) for moulding a second shear web, wherein each of said first and second web moulds (23, 24) comprises a first end (30), a second end (31), a first side (32) and a second side (33), characterised in that the first web mould (23) is arranged at a ground level (20) and the second web mould (24) is arranged at an upper level (21) located above the ground level (20).

2. The moulding station according to claim 1, characterised in that said upper level (21) is formed by a working platform (22) extending in a longitudinal direction and in a transverse direction, wherein said first web mould (23) is arranged below said working platform (22).

3. The moulding station according to claim 1, characterised in that at least a third web mould (25) is further arranged at the ground level (20) relative to the first web mould (23) and/or at the upper level (21) relative to the second web mould (24), the third web mould (25) comprising a moulding surface (34) for moulding at least a third shear web.

4. The moulding station according to claim 3, characterised in that said first or second web mould (23, 24) and said third web mould (25) are aligned in the longitudinal direction.

5. The moulding station according to claim 3, characterised in that said first or second web mould (23, 24) and said third web mould (25) are aligned in the transverse direction.

6. The moulding station according to claim 1, characterised in that the moulding station (19) further comprises a lifting system (35, 37) configured to lift a selected shear web between a first position and a second position, wherein said lifting system (35, 37) are configured to move relative to at least the first or second web mould (23, 24).

7. The moulding station according to claim 1, characterised in that the moulding station further comprises at least one post-moulding substation (27) arranged at the ground level (20) or the upper level (21).

8. A method of manufacturing a shear web component for a wind turbine blade, the method comprises the steps of:
providing a moulding station (19) comprising a first web mould (23) and at least a second web mould (24),
manufacturing a first shear web in said first web mould (23) using a moulding process,
further manufacturing a second shear web in said second web mould (24) using a moulding process,
characterised in that
said manufacturing of the first shear web is performed at a ground level (20) while said further manufacturing of the second shear web is performed at an upper level (21), the upper level (21) being located above the ground level (20).

9. The method according to claim 8, characterised in that the method further comprises the step of:
moving said first or second shear web to a post-moulding sub-station (27) using a lifting system (35, 37) of the moulding station (19).

10. The method according to claim 8, characterised in that a first set of shear webs of one wind turbine blade (5) are manufactured at one level (20) while a second set of shear webs of another wind turbine blade (5) are manufactured at another level (21).

11. The method according to claim 8, characterised in that a first set of shear webs of one wind turbine blade (5) are manufactured in selected web moulds at the ground and upper levels (20, 21) and while a second set of shear webs of another wind turbine blade (5) are manufactured in further selected web moulds at the ground and upper levels (20, 21).
